(19) United States
(12) Patent Application Publication
(10) Pub. No.: US 2007/0206782 A1
(43) Pub. Date: Sep. 6, 2007

(54) Handset for mobile phone

(76) Inventor: Alexander Mak, Hong Kong (CN)

Correspondence Address: Mr. Eric Chan, 42 Pin Oaks Drive, Phoenixville, PA, 19460, US

(21) Appl. No.: 11/358,532

(22) Filed: Feb. 22, 2006

(51) Int. Cl. H04M 1/00; H04M 9/00

(52) U.S. Cl. 379/433.01

(57) ABSTRACT

The present invention relates to a handset for mobile phone comprising an earpiece, a handle and a mouthpiece; the earpiece and the mouthpiece are disposed on the two sides of the handle and are connected to the handle; one side of the mouthpiece is connected to a connection cord; the connection cord is a removable connection cord with different plugs disposed on its two ends for connecting to the mouthpiece and the mobile phone respectively. The present invention provides a handset for mobile phone which has good communication quality, low production costs and a trendy and unique design.

### BACKGROUND OF THE INVENTION

The present invention relates to mobile phone accessories and more particularly pertains to a handset for mobile phone.

Mobile phones are widely used nowadays. The available mobile phones make use of build-in loudspeakers and microphones for sound reception and transmission. These mobile phones, however, operate in close proximity to the human body. Microwave radiation emitted by the mobile phones might jeopardize human health. To solve this problem, mobile phones are often equipped with earpiece devices. These earpiece devices are small in size and easy to carry around, but they have poor communication quality and they are easily interfered by surrounding noise. Moreover, the way of using earpiece devices deviates a lot from the traditional practice of using conventional telephones.

### BRIEF SUMMARY OF THE INVENTION

In view of the aforesaid disadvantages now present in the prior art, the object of the present invention is to provide a handset for mobile phone which has good communication quality, low production costs and a trendy and unique design.

To attain this, the present invention generally comprises an earpiece, a handle and a mouthpiece; the earpiece and the mouthpiece are disposed on the two sides of the handle and are connected to the handle.

One side of the mouthpiece is connected to a connection cord.

The connection cord is a removable connection cord with different plugs disposed on its two ends for connecting to the mouthpiece and the mobile phone respectively.

The earpiece comprises an upper earpiece cover, a loudspeaker device and a lower earpiece cover. The upper earpiece cover and the lower earpiece cover are coupled and connected to form a hollow space in between. The loudspeaker device is fixedly disposed inside the hollow space.

The mouthpiece comprises an upper mouthpiece cover, a microphone device and a lower mouthpiece cover. The upper mouthpiece cover and the lower mouthpiece cover are coupled and connected to form a hollow space in between. The microphone device is fixedly disposed inside the hollow space.

A printed circuit board is disposed inside the handle; the printed circuit board is connected with the loudspeaker device and microphone device respectively.

The handle has a curved shape. The curved handle fits better with the head of a user so that the earpiece and the mouthpiece are positioned closer to the user's ear and mouth respectively.

The present invention can also comprise a caller ID display module; the caller ID display module can be connected to the printed circuit board; the caller ID display module can comprise a liquid crystal display (LCD) monitor; the LCD monitor can be disposed on the side of the earpiece, the handle or the mouthpiece.

The present invention, in comparison with known arts, has the following advantages and effects. First, the earpiece and the mouthpiece of the present invention are positioned closer to the user than those of the known arts and have more accurate transmission and reception directions. The present handset is less interfered by surrounding noise and communication quality is highly enhanced. Second, the shape of the present invention is closer to traditional handsets. As people in general are more familiar with using traditional handsets, users generally find it easier and more convenient to use the present invention rather than earpiece devices. Third, combined use of the present handset and mobile phone produces novel and unique effect and are more fashionable and trendy.

### BRIEF DESCRIPTION OF THE DRAWINGS

FIG. 1 is a schematic view of the handset for mobile phone of the present invention.

FIG. 2 shows the connection cord of the handset for mobile phone of FIG. 1.

FIG. 3 is a disassembling view of the handset for mobile phone of FIG. 1.

FIG. 4 is a circuit diagram of the handset for mobile phone of FIG. 1.

### DETAILED DESCRIPTION OF THE INVENTION

The present invention is further described in detail with the following embodiment and the accompanying drawings, which should not be regarded as limiting.

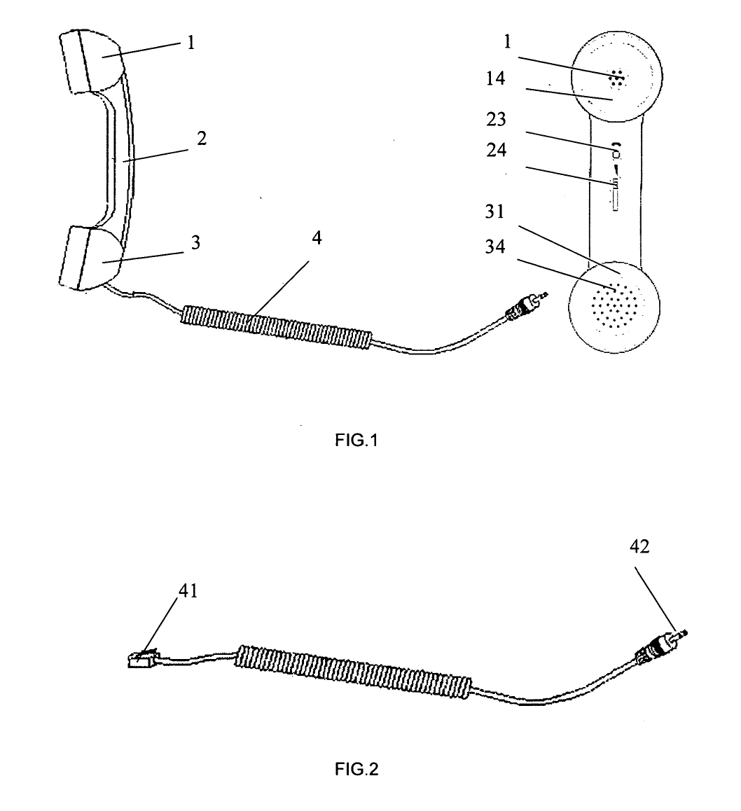

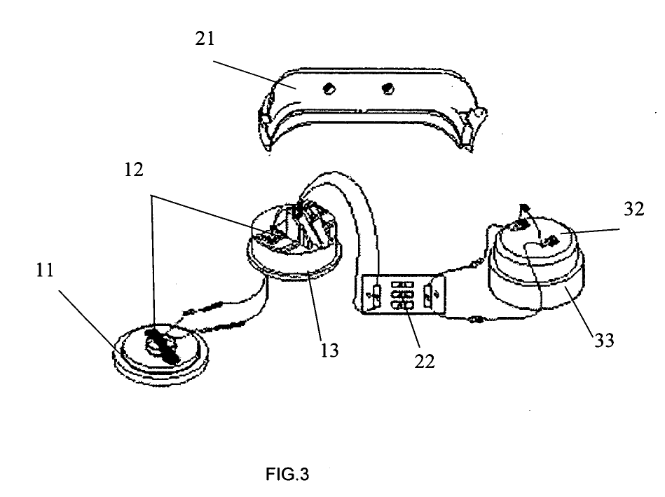

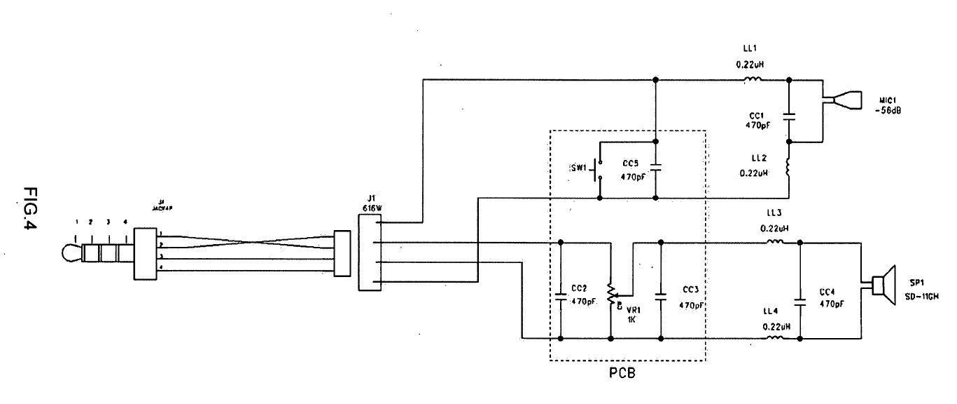

FIG. 1 is a schematic view of the handset for mobile phone of the present invention. As illustrated in FIG. 1, the handset for mobile phone of the present invention is similar to handsets of traditional telephones. It comprises an earpiece 1, a handle 2 and a mouthpiece 3; the earpiece 1 and the mouthpiece 3 are disposed on the two sides of the handle 2 and are connected to the handle 2; one side of the mouthpiece 3 is connected to a connection cord 4; the connection cord 4 is a removable connection cord. As illustrated in FIG. 2, a rectangular plug-with a spring chip 41 and a cylindrical plug 42 are disposed on the two ends of the connection cord 4 and are connected to the mouthpiece 3 and the mobile phone respectively. The structure of the handset is illustrated in FIG. 3. As illustrated in FIG. 3, the earpiece 1 comprises an upper earpiece cover 11, a loudspeaker device 12 and a lower earpiece cover 13. The upper earpiece cover 11 and the lower earpiece cover 13 are coupled and connected to form a hollow space in between. The loudspeaker device 12 is fixedly connected to the upper earpiece cover 11 and the lower earpiece cover 13 respectively and is disposed inside the hollow space. Holes 14 are opened on the upper earpiece cover 11 to enhance transmission quality. The mouthpiece 3 comprises an upper mouthpiece cover 31, a microphone device 32 and a lower mouthpiece cover 33. The upper mouthpiece cover 31 and the lower mouthpiece cover 33 are coupled and connected to form a hollow space in between. The microphone device 32 is disposed inside the hollow space and is fixedly connected to the lower mouthpiece cover 33. Holes 34 are opened on the mouthpiece 3 to enhance reception quality. The handle 2 comprises a handle casing 21 and a printed circuit board 22. The handle casing 21 is slightly curved. The printed circuit board 22 is fixedly disposed in the handle casing 21 and is connected with the loudspeaker device 12 of the earpiece 1 and the microphone device 32 of the mouthpiece 3 through connection wires. The circuit diagram is shown in FIG. 4. A control switch SW1 (equivalent to switch 23 in FIG. 1) and a slide resistor VR1 (equivalent to slide deflector rod 24 in FIG. 1) of the printed circuit board (PCB) are disposed inside the handle 2 to control signal communication and earpiece volume respectively. The present handset for mobile phone can also comprise a caller ID display module (not shown in the drawings); the caller ID display module is connected to the printed circuit board; the caller ID display module comprises a liquid crystal display (LCD) monitor; the LCD monitor can be disposed on the side of the earpiece, the handle or the mouthpiece.

The above embodiment is a preferred embodiment of the present invention. The present invention is capable of other embodiments and is not limited by the above embodiment. Any other variation, decoration, substitution, combination or simplification, whether in substance or in principle, not deviated from the spirit of the present invention, is replacement or substitution of equivalent effect and falls within the scope of protection of the present invention.

What is claimed is:

1. A handset for mobile phone comprising an earpiece, a handle and a mouthpiece; the earpiece and the mouthpiece are disposed on the two sides of the handle and are connected to the handle.

2. The handset for mobile phone as in claim 1, wherein one side of the mouthpiece is connected to a connection cord.

3. The handset for mobile phone as in claim 2, wherein the connection cord is a removable connection cord with different plugs disposed on its two ends for connecting to the mouthpiece and the mobile phone respectively.

4. The handset for mobile phone as in claim 1, wherein the earpiece comprises an upper earpiece cover, a loudspeaker device and a lower earpiece cover; the upper earpiece cover and the lower earpiece cover are coupled and connected to form a hollow space in between; the loudspeaker device is fixedly disposed inside the hollow space.

5. The handset for mobile phone as in claim 1, wherein the mouthpiece comprises an upper mouthpiece cover, a microphone device and a lower mouthpiece cover; the upper mouthpiece cover and the lower mouthpiece cover are coupled and connected to form a hollow space in between; the microphone device is fixedly disposed inside the hollow space.

6. The handset for mobile phone as in claim 1, wherein a printed circuit board is disposed inside the handle; the printed circuit board is connected with the loudspeaker device and microphone device respectively.

7. The handset for mobile phone as in claim 1, wherein the handle has a curved shape.

8. The handset for mobile phone as in claim 1, wherein it further comprises a caller ID display module; the caller ID display module is connected to the printed circuit board; the caller ID display module comprises a liquid crystal display (LCD) monitor; the LCD monitor is disposed on the side of the earpiece, the handle or the mouthpiece.
